(19) United States
(12) Patent Application Publication
(10) Pub. No.: US 2008/0053946 A1
(43) Pub. Date: Mar. 6, 2008

(54) Confined space entry device and related method of assembly

(75) Inventors: Gary K. Choate, Lakewood, CO (US); Dustin L. Hawkins, Portland, OR (US); Edward Inman, Denver, CO (US)

Correspondence Address: Thomas H. Young, 5500 Hawthorn Cir., Greenwood Village, CO, 80121, US

(73) Assignee: T.A. Pelsue Company, Englewood, CO (US)

(21) Appl. No.: 11/786,539

(22) Filed: Apr. 12, 2007

Related U.S. Application Data
(63) Continuation of application No. 11/090,745, filed on Mar. 24, 2005, now abandoned.
Application No. 11/090,745 is a continuation of application No. 09/831,131, filed on Nov. 26, 2002, now abandoned.
(60) Provisional application No. 60/158,406, filed on Oct. 7, 1999.
(60) Provisional application No. 60/190,772, filed on Mar. 20, 2000.

(51) Int. Cl. B66C 23/00

(52) U.S. Cl. 212/306

(57) ABSTRACT

A confined space entry device and/or fall arrester for use in securing a person working at elevation, the device including modularized components which allow it to be readily reconfigured. In particular, the extension arm of the device is removably secured to one end of an elbow, the other end of which is removably secured to a post or mast which is securely anchored, for example, to a base. The device can include arms and elbows of different configurations and lengths for various applications in the field. In one embodiment, the mast, arms and/or elbows may be tubular members made from a composite material that is sufficiently elastic to absorb forces to arrest a falling person, but sufficiently resilient to deform and return to its original configuration

### TECHNICAL FIELD

The present invention relates to a confined space entry and high-height anchorage device and a related method of assembly.

### BACKGROUND ART

Confined space entry products and devices are currently used in many applications requiring “man rated” lifting and lowering capabilities as described by OSHA and ANSI Regulations. These devices are typically rigid structures that must be carried manually to a work site and erected for a specific use. Typical uses are entry into manholes, tank manways, over the edges of walking/working surfaces, off the edges of power transformers, over bridge edges, into chimneys and flues, into underground tunnels, and any other locations where entry is made difficult due especially to space constraints.

Since these devices generally need to be packed, transported, and carried manually to a desired site, it is particularly advantageous for the devices to be highly portable and lightweight. Current construction of these products is generally by welding of lightweight aluminum, steel, or other metal alloys. The parts or components are produced in sections that can be separated for crating and movement, but critical load-bearing sections, such as elbows, offsets, and bases are generally produced using welded, ribbed, structures in order to carry the loads prescribed by OSHA regulations. The use of such designs produces heavy sections that are cumbersome to move and assemble; other, lighter designs are often inadequate to carry the required loads for many applications.

A confined space entry device is used in a variety of applications, in spaces of varying dimensions or varying space constraints. For example, different applications or varying field conditions may require the arm of the device to be “offset” from the vertical post or mast by different amounts. Under the current art, in order to vary such offset, multiple, cumbersome pieces generally need to be brought to the site and kept available, and cumbersome manipulations are required before the offset can be changed.

In some applications, it is also desirable for confined space entry devices to absorb a certain amount of force generated by a person arresting a fall while using the device. For example, for certain applications it is advantageous to absorb the force of a 220-pound person arresting a six-foot fall on a hoist line of specified characteristics, without such hoist line reaching its breaking strength. The approaches of the current art to this matter often involve cumbersome shock-absorbing solutions.

### DISCLOSURE OF INVENTION

The device of the present invention is used in relation to confined spaces and high-height anchorage/tie-offs. The device can be readily assembled and disassembled in the field by virtue of its modularity, that is, by using multiple, elongated members which are removably secured to corresponding joint sections. One joint section is an elbow having two legs extending outwardly at an angle from a central axis. The elongated members include a post extending from one of the elbow legs and an extension arm extending from the other of the elbow legs. The free end of the extension arm is spaced a lateral distance from the post to define an offset useful in entering or exiting confined spaces. Suitable structures for hoisting men and loads into and out of the confined space are operatively connected to the device of the present invention.

According to another aspect of the present invention, a davit assembly is adapted for use with any of a variety of bases. The davit assembly and the base together comprise a confined space entry device. The davit assembly has a post and an extension arm which are formed from a non-metal, polymer matrix composite material. The post and the extension arm are interconnected by means of an elbow. The post connects to one leg of the elbow and the extension arm connects to the other leg of the elbow. The extension arm extends from the post and terminates in a free end defining an offset to the davit assembly.

The davit assembly can be equipped with a set of extension arms of varying lengths, such that the offset of the davit assembly can be correspondingly varied by merely interchanging extension arms connected to the elbow of the davit assembly.

In still another aspect of the invention, the davit assembly makes use of an asymmetric elbow, that is, an elbow with a longer leg and a shorter leg. Each of the legs is structured so that it can slidably engage and be removably secured to either one of the post and the extension arm. In this way, a single extension arm can be used to create two, different offset lengths, depending on whether the extension arm is connected to the longer leg of the elbow or the shorter leg of the elbow.

### BRIEF DESCRIPTION OF THE DRAWINGS

FIG. 1A is an isometric view of a confined space entry and high height anchorage/tie-off device, illustrating one preferred embodiment of the present invention;

FIGS. 1B and 1C are enlarged sectional views of the securing location of the extension arm shown in FIG. 1A;

FIG. 2 is an isometric view of a transformer-type confined space entry device, illustrating another preferred embodiment of the present invention;

FIG. 3A is an exploded, side elevational view of another confined space entry device, illustrating still another preferred embodiment of the present invention;

FIGS. 3B and 3C are partial views of alternative joints for the embodiment shown in FIG. 3A;

FIGS. 4A through 4D are top plan views of a variety of base configurations available for the confined space entry devices of the present invention;

FIGS. 4E through 4G are top plan and side elevational views of base configurations available for transformer-type confined space entry and high height anchorage/tie-off devices;

FIG. 5 is an enlarged, sectional view of a base joint according to the present invention;

FIGS. 6A through 6E are side elevational views of a modular davit assembly according to the present invention;

FIGS. 7 and 8 are side and front elevational views of an elbow according to still another aspect of the present invention; and

FIGS. 9 and 10 are perspective views of a davit assembly incorporating the elbow of FIGS. 7 and 8 therein.

### MODES FOR CARRYING OUT THE INVENTION

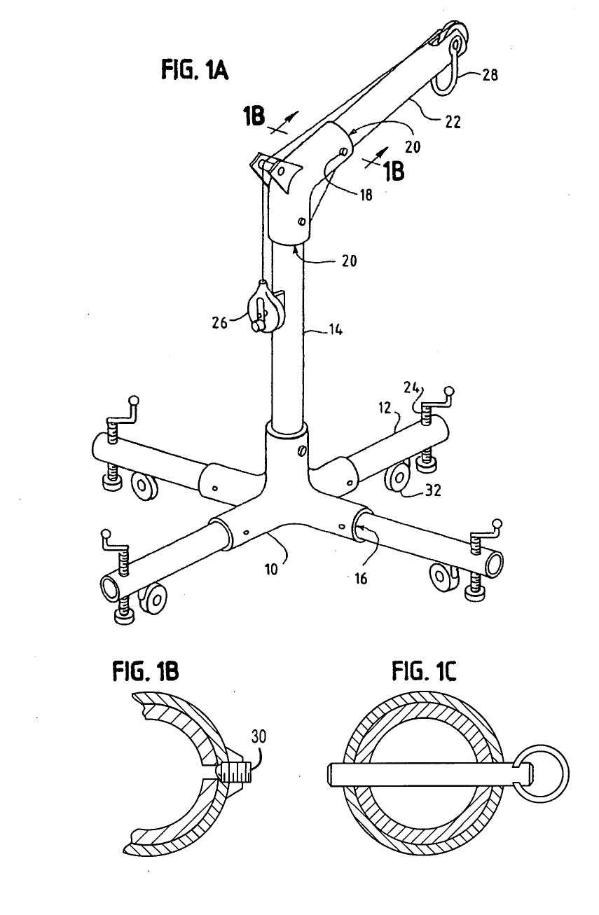

Referring to FIGS. 1A to 5, a confined space device, according to one preferred embodiment of the present invention, includes an “X” base frame 10 having four legs 12 connected to a vertical elongated section, post, or mast 14 through the use of a cast “X” base frame 10. Confined space devices often are used to provide high height anchorage or tie off; accordingly, in this application, the use of the term “confined space entry device” or “confined space device” includes the possibility of using such devices for high height anchorage.

The cast “X” base frame 10 receives leg tubes 12 by slidably inserting leg ends into corresponding openings in the cast “X” base joint 16. The vertical elongated section 14 of the structure extending vertically from the cast “X” base 10 terminates in an upper end which is slidably received in a corresponding structure in cast elbow 18. The opposing ends of elbow 18 and post or mast 14 are preferably joined in a manner similar to that used to connect post or mast 14 to base 10 frame.

Extension arm 22 extends from the other end of elbow 18, and the horizontal component of extension arm 22 defines an “offset” relative to the post or mast 14.

The vertical elongated section 14 is pivotable in the “X” base 10 and will swivel 360° without interruption. The offset extension arm 22 extending from the elbow 18 is interchangeable with a variety of lengths of tubing, defining a set of extension arms, to create a corresponding set of offset distances available to the user of the device. Similarly, the vertical elongated section 14 is interchangeable with a variety of lengths of tubing to create variety of different heights of the system. Further, the leg sections 12 are replaceable in the “X” base 10 with tubing of alternate lengths, defining a set of legs 12, so that the device can be equipped with whatever base dimensions and leg length required for stability. The top of each leg contains a leveling screw 24 to level the structure in its preferred embodiment. Each leg end may also contain a wheel 32, which can be used to make the system mobile on flat surfaces. A retractable device 26 is attached to the vertical elongated section 14 to provide an anchorage for the worker. Other hoists and anchorages may also be attached to the device of the present invention, such as to the U bracket 28.

All tubing sections and joints in the system can be disassembled and loaded into carrying cases for easy transport to a work area whether elevated or not. This eliminates long sections with bends as is necessary on welded metal davits.

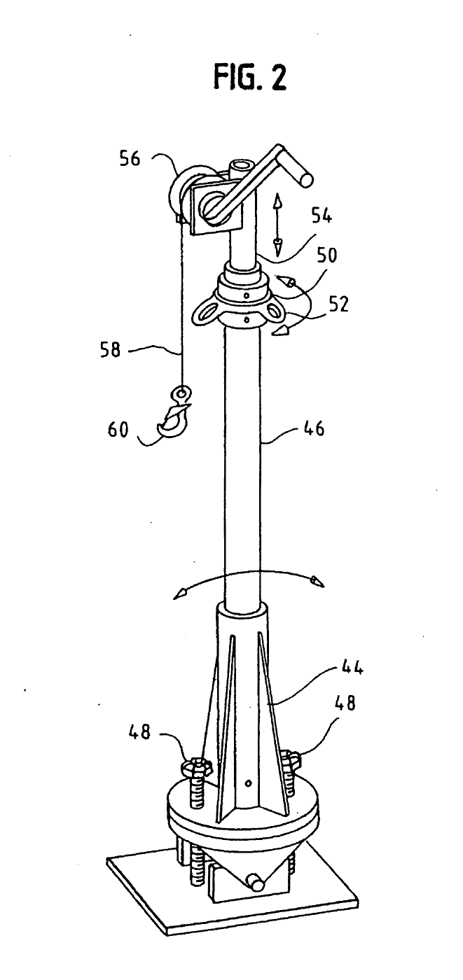

Referring more particularly to FIG. 2, a transformer-type confined space device includes a mast 46 extending from a cast base 44. The mast is preferrably made of composite fiber, as discussed in more detail below. The cast base contains adjusting screws 48 that can be used to adjust the mast from side to side. A pivotal ring 50 at the top of the mast 46 allows the workers to attach to the mast by snapping into the rings 52. All three rings are joined in one plate and swivel as a unit around the mast 46. An additional extension mast 54 may be inserted into the vertical mast 46 and used to anchor a hoist 56 for the added purpose of lifting or lowering a person or materials attached to the safety line 58 at the snap 60. Note that to assemble the transformer davit in this configuration requires no welding, only slip together, pre-made sections made by the previously mentioned methods and processes. Additionally, a boom mount hoist may be anchored to one of the attachment points in the pivotal ring 52 as an additional method for using a rescue hoist.

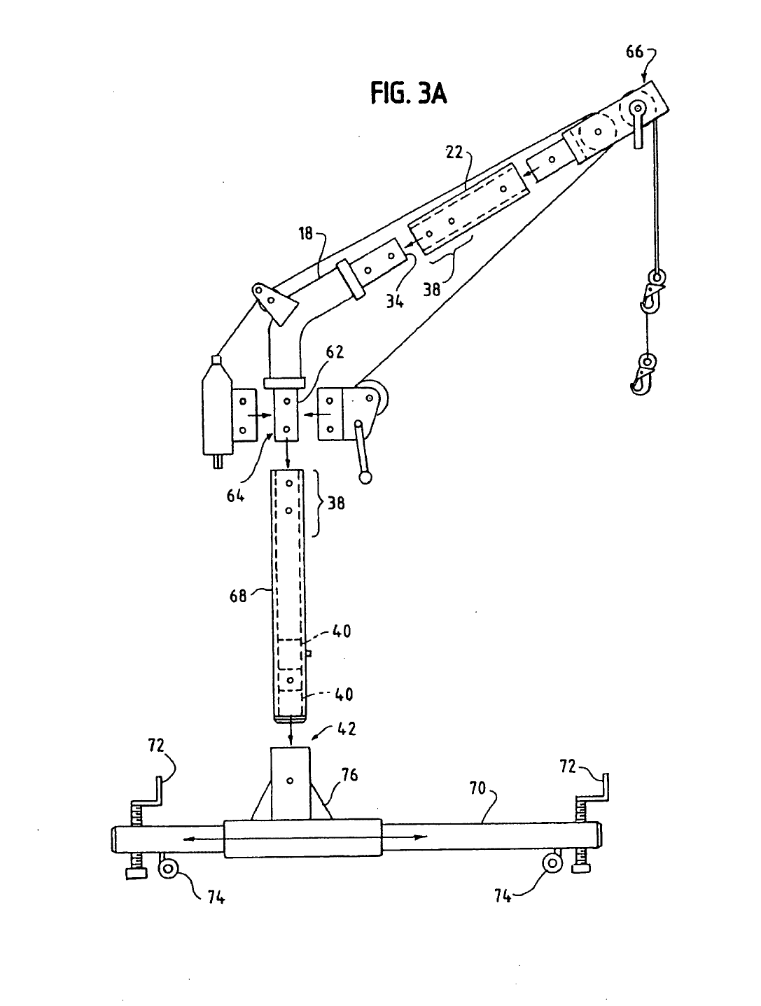

FIG. 3A illustrates the elbow 18 of FIG. 1A in the context of another embodiment of the present invention. In particular, offset extension arm 22, in the form of a tube, is inserted over an end of the elbow 18. Mast 68 in this embodiment includes rigid sleeve inserts 40 to control dimension, add stiffness, and reduce stress at the joint with base 76 and reduce the risk of crushing mast 68 under compressive loads. Additionally, FIG. 3A shows hoist mount 62 and the retractable mount 64 for use in handling loads secured to the device. A cable extends from the free end of extension arm 22. Reeving of this cable is shown through the nose assembly 66.

Offset extension tube 22, vertical post or mast tube 68, leg tube 70, and other elongated members of the device can be formed of aluminum, aluminum composite or carbon-composite material. The devices of FIGS. 1 through 5 include davit assemblies extending from bases, and such bases are provided with leveling screws 72 and casters 74 to enable ease of positioning once assembled. The composite fiber legs 70 are slidable through the “H” base frame 76.

FIG. 3B shows a variation on attachment of the extension tube 22 to elbow 18. In order to avoid distortion of the tube due to stress at the elbow exit point 34, a rigid sleeve 36 has been inserted into the tube 22. Referring to FIG. 3C, special high-strength inlays and additional fiber reinforcement may be added to this area 38 to increase strength and improve stiffness. Rigid sleeve inserts 140 are added to control dimension, add stiffness, and reduce stress at exit area 42.

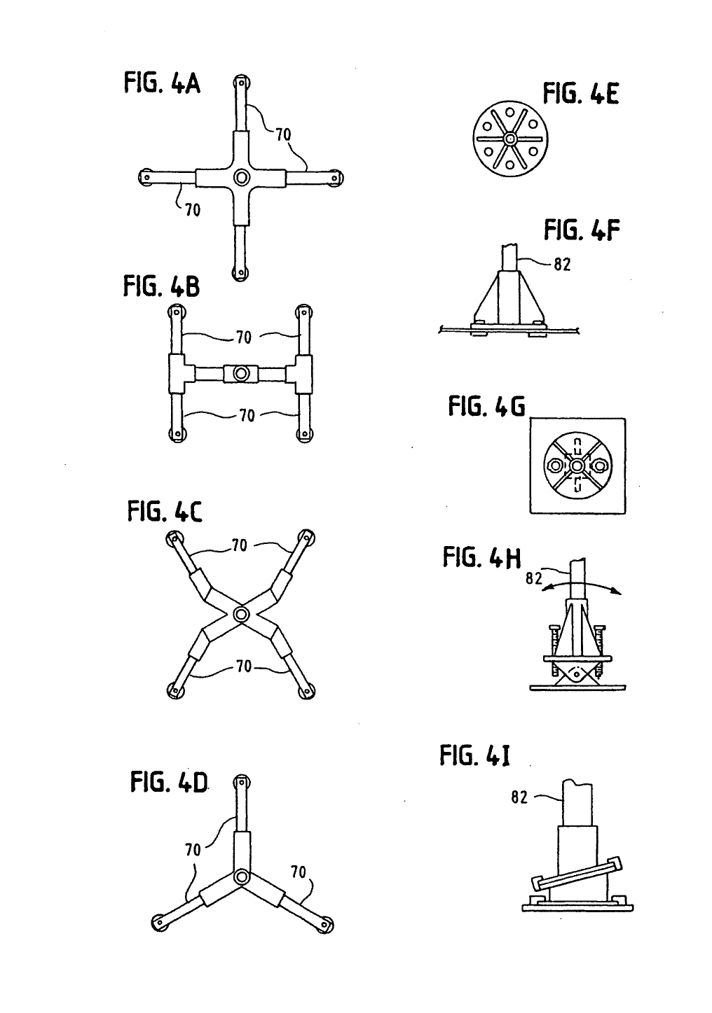

Referring now to FIG. 5, an “H” base support is shown with details of the tube inserts similar to those shown in FIG. 3B. Experience has shown that the tubing of the elongated members can be crushed by high compressive loads that are encountered against rigid supports. To overcome this problem and allow the composite fiber or aluminum tube to absorb the maximum amount of energy, rigid inserts 92 and 94 are secured at joint 88 at selected locations. In FIG. 5, the “H” base is shown supporting the composite fiber tube 82 inside a sleeve 84 against elastomer bearing 86. When a side load is placed on the composite fiber or aluminum tube, excessive compressive loads can be created at 88 and 90. To keep the tube from crushing, rigid inserts 92 and 94 are attached to the inside of the tubing by gluing or pinning. The inserts are located at the base of each tube and at each transitional location such as the exit from a support 96. Similar inserts are useful at other joints of the device.

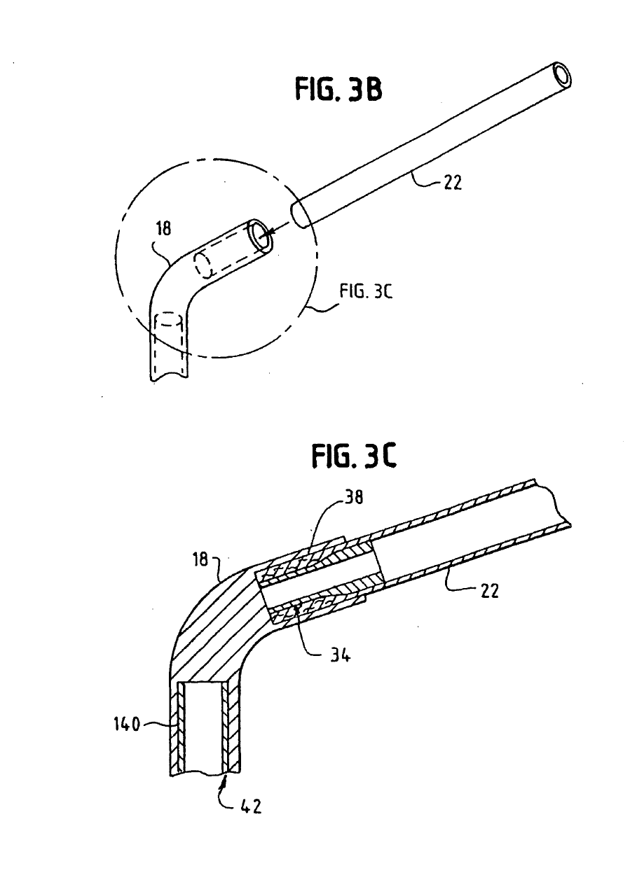

Referring now to FIGS. 4A through 4G, composite fiber, aluminum, or aluminum composite tubes 70, 82 can be used with corresponding joints or sections to form a variety of different bases for the confined space device, namely: an X base (FIG. 4A), an H base (FIG. 4B), a modified X base (FIG. 4C), a triangle base (FIG. 4D), a fixed transformer base (FIG. 4E), a pivotal transformer base (FIG. 4F), and a swivel base for transformers (FIG. 4G).

In one preferred aspect of this invention, the elongated of the device members shown in FIGS. 1A through 5 are tubes formed from composite materials. The elongated members formed from composite material include extension tube 22, post or mast tube 68, and leg tube 70. Composite materials include lightweight carbon fiber, kevlar fiber, fiberglass and lightweight aluminum-ceramic composites. The preferred composite material is chosen to be sufficiently elastic to absorb forces of a person arresting a predetermined free fall, but sufficiently resilient to deform and still return to its original position.

This combination of plug-in sectional assembly and super-light weight, highly elastic, composites with up to ten times the strength of previous materials enables this invention to be used as a highly portable confined space and tall arrest product in spaces and geometric load-bearing arrangements previously unobtainable by any prior art.

With the ability of the composite fiber structures to deform significantly under stress, it gives them the ability to absorb significant amounts of fall arrest energy. This energy can be determined by using the equation:
E=½T×D
Where:
T=maximum fall arrest line tension
   D structural deflection

It has been shown by testing that a structural deflection of 10.5 inches is possible with a fall arrest line tension of 3000 lbs. This means that the anchorage structure can absorb as much as:
E=½(3000 LBS.)×(10.5 in.)×(1 ft./12 in.)=1312.5 ft-lbs.
of energy. A 220-lb. person falling 6-ft. (per OSHA regulations limiting free-fall distances) can generate:
E=(220 lbs.)×(6 ft.)=1320 ft-lbs.

On preferred composite material is a polymer matrix composite material suitable for absorbing energy in the amounts indicated above, while remaining sufficiently resilient. More particularly, the elongated members of the device comprise a filament-wound carbon fiber tube that is an epoxy-based, non-isotropic composite structure formed from pre-peg sheet goods. Tubes from such material have walls with a thickness of 0.120 inches. Other composite materials suitable for forming elongated members of the device have the following general characteristics: the resulting members are between eight to twelve times as strong as equivalent aluminum tubing, able to withstand between two to four times the stress of typical aluminum tubing, and retains a high modulus of elasticity.

Use of composite materials allows extension arms of the present invention to have greater lengths, thereby giving a greater selection of offsets to confined space entry device of the present invention. Composite material also absorbs increasing amounts of energy with increasing length. Testing has shown that the length of post members, such as the mast 46 of FIG. 2, can satisfy predetermined strength and fall arrest characteristics even at heights up to 72 inches, whereas conventional systems were required to be much shorter, on the order of 42 inches, to satisfy the same requirements. Similar tests have shown that use of composite material reduces arrest forces by one-third in many applications.

As such, the composite tubes greatly increase worker safety. It provides backup security so that if the worker should fall while attached to the structure without using a sufficient shock absorbing lanyard, the structure itself can absorb enough energy to reduce the chances of the lanyard line and anchorage structure failing.

Joint sections are preferably locked with thru bolts 30 or detent pins 130, as shown in FIGS. 1B and 1C, respectively, or by ball-lock pins, ball detents (not shown), or other suitable means such as screwing, gluing, etc.

The detachable components of the confined space entry device of FIGS. 1-5, that is, base 16, leg tubes 12, post tube 14/68, elbow 18, and extension tube 22, may alternatively be made of cast aluminum or cast composite fiber, extruded aluminum, aluminum composite, or injection molded of composite fibers, plastics, or metals, or made by a composite fiber lay-up molding process as described in the following U.S. Pat. Nos. 4,850,607; 4,889,355; 4,902,458; 4,923,203; 4,941,674; 4,982,975; 4,986,949; and 5,158,73.3, the teachings of which are incorporated herein by reference:

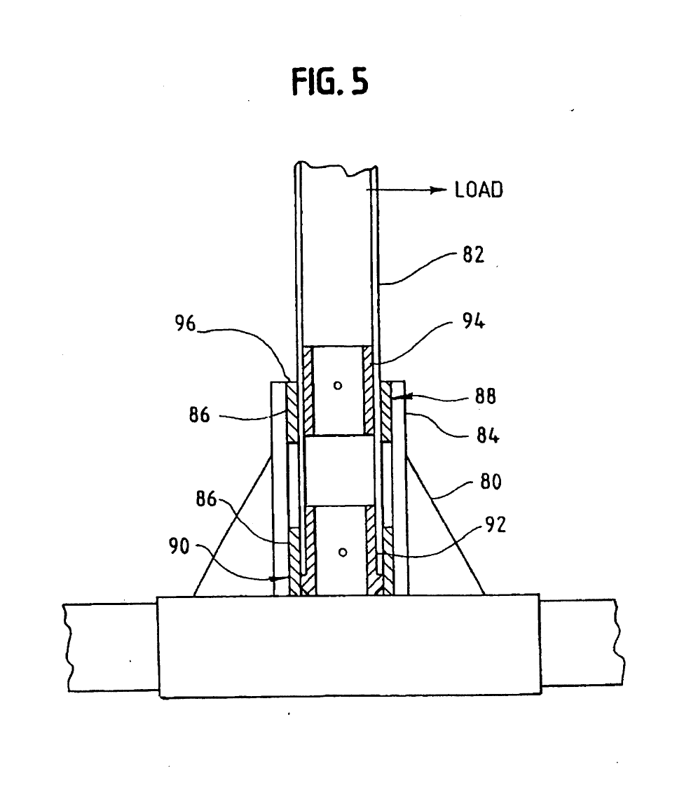

The flexibility, versatility, and assembly of the confined entry device of the present invention is apparent from the foregoing description, and with further reference to FIGS. 6A through 6E. In particular, FIGS. 6A-6E illustrate a davit assembly 111 suitable for use with any of the bases shown in FIGS. 4A through 4G to form a confined space entry device. Davit assembly 111 includes vertical or post member 114 with lower post end 116 adapted to be fitted to one of the davit bases illustrated in FIGS. 4A-4G, and upper post end 117 adapt to be secured to elbow 118. The joint between upper post end 117 and elbow 118 is rendered secure by means of a locking pin collar 119 with a pair of associated locking pins 121. Preferably, there is no need for weld or weld points to secure upper post end 117 relative to elbow 118. Elbow 118 has ends with sleeves substantially similar to sleeves 64 illustrated in FIG. 3, such sleeves slidably engaging post end 117.

The amount of “offset” from post member 114 can be easily varied by virtue of the “componentized” or modular nature of the present invention, as illustrated in FIGS. 6A-6E and now explained. Using the same elbow 118 and post member 114, an 18-inch “offset” is achieved by securing suitably dimensioned extension tube 122 to the upper end of elbow 118. Extension tube 122, like the other tubes 22 discussed in FIGS. 1-5, is preferably removably attached to elbow 118, that is without permanent welds or other permanent securing means. In this way, extension tube 122 can be readily attached and detached from elbow 118 to vary the amount of offset for davit assembly 111. In particular, FIG. 6B shows a longer extension tube 122 which is of a suitable length to provide for a 24-inch offset. Similarly, FIGS. 6C through 6E show extension tubes 222, 322, and 422, respectively, which are suitably dimensioned to provide offsets of 30 inches, 36 inches, and 48 inches.

In view of the foregoing, davit assembly 111 can be varied from offsets of 18″ all the way to offsets of 48″ by simply providing corresponding extension tubes. This approach avoids the need for cumbersome bent or welded tubing typically found in the current art. As such, the user can be equipped with a set of different-length extension tubes and merely needs to carry these different tubes along with the balance of the davit assembly 111 to the field. Where so equipped, the user can readily vary the structure of the davit assembly “on the fly,” as different applications demand different “offsets.”

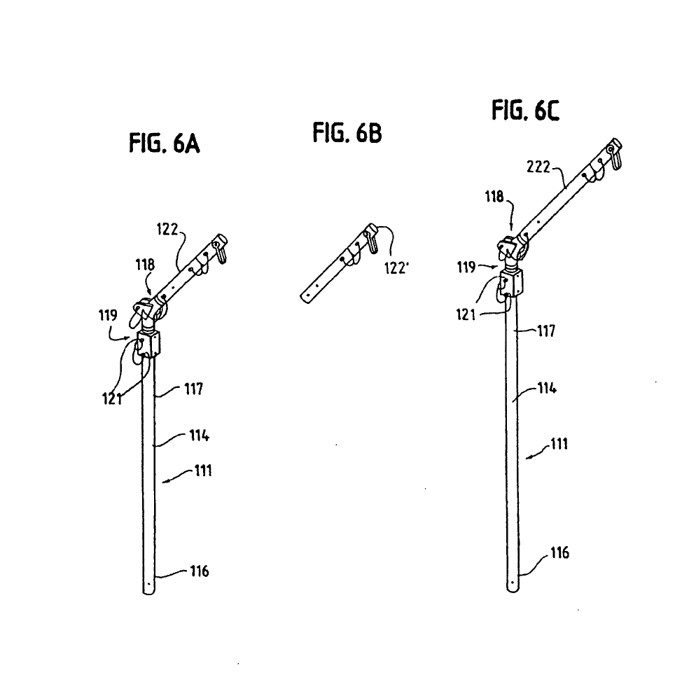

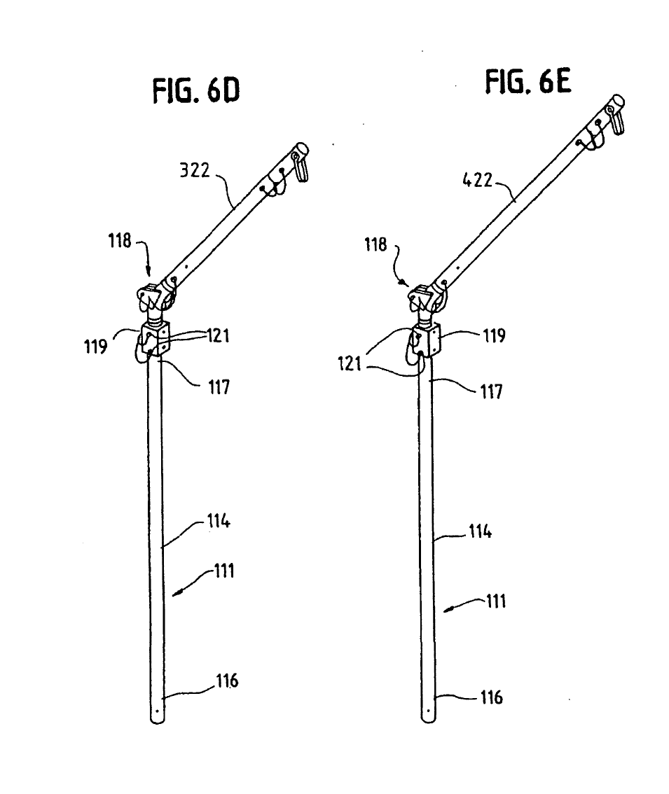

FIGS. 7-10 illustrate another preferred embodiment of the present invention. In this embodiment, elbow 718 is preferably formed of cast metal, more preferably cast aluminum. Significantly, elbow 718 is asymmetric about its central axis 719, as shown in FIG. 7. Otherwise stated, elbow 718 has a shorter leg 721 and a lower leg 723, and legs 721, 723 are joined at their inside ends to give an angle α to elbow 718. Elbow 718 includes a web or gusset 725 as part of its casting and a retainer 727 for use in conjunction with hoist lines of the davit assembly.

Each of the legs 721, 723 includes outer ends 729 adapted to receive elongated, preferably tubular members. In the illustrated embodiment, the ends of tubular members are received into apertures 731 defined in outer end 729.

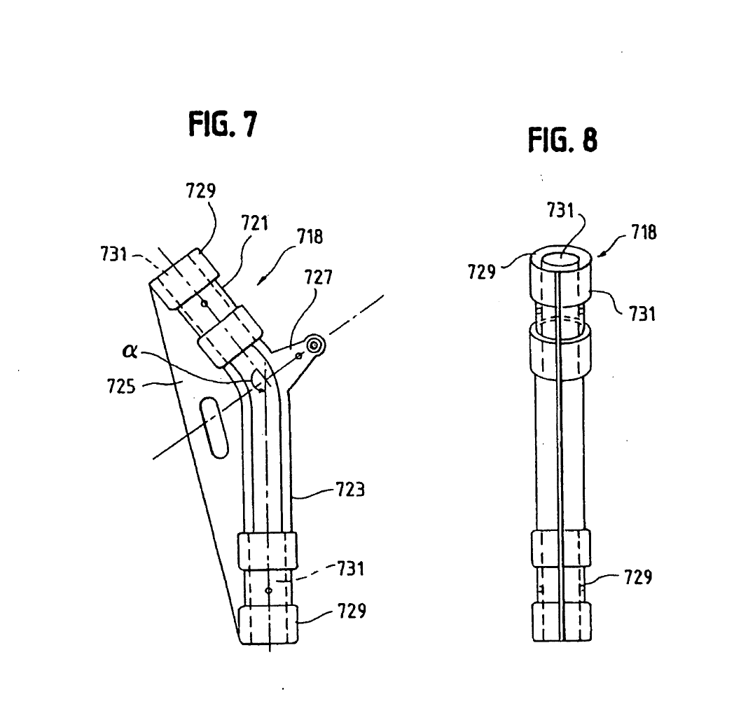

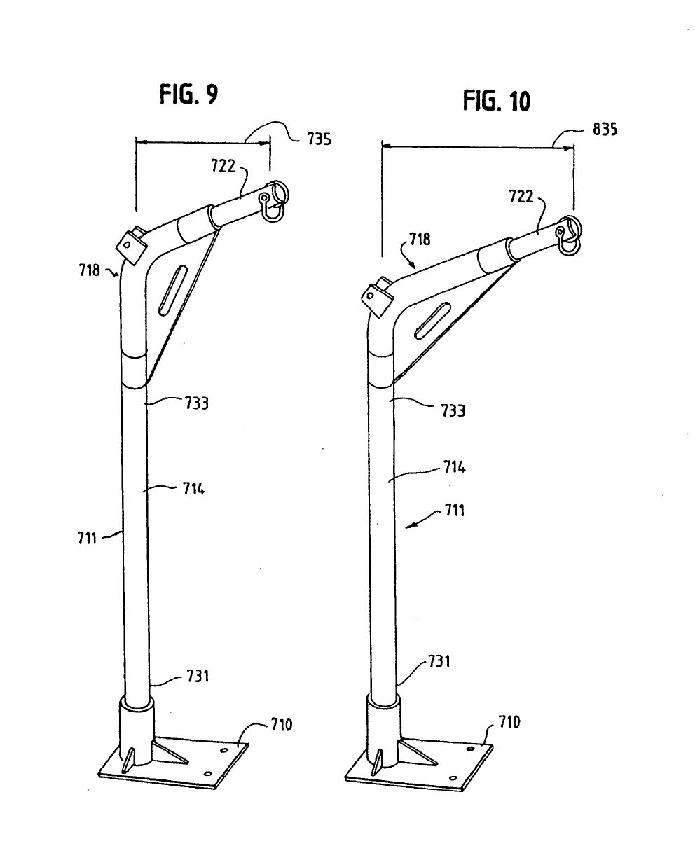

Elbow 718 is part of a davit assembly, which in turn is part of a confined space entry device 711 similar to those illustrated in FIGS. 1-6. Similar to the elbows illustrated in FIGS. 1-6, elbow 718 attaches at one of its ends to the vertical or post tube 714 of the confined space device and, at its other end, to a suitable extension tube 722 (FIGS. 9 and 10). Still referring to FIGS. 9 and 10, elbow 718 is shown as part of a fixed base confined space entry device 711. As in the previously described embodiments, vertical tube 714 is removably received at its lower end 731 into a suitable base 710, shown here as a bolt down or weld down base.

Referring now particularly to FIG. 9, the longer leg 723 of elbow 718 is connected as its end 729 to the upper end 733 of post member 714. The opposite, shorter leg 721 of elbow 718 is oriented upwardly, and extension tube 722 is received in shorter leg 721. In the configuration shown in FIG. 9, extension tube 722 is selected so as to create a horizontal offset 735 of approximately 18 inches.

The versatility and advantages of elbow 718 are illustrated by contrasting the above-described configuration of FIG. 9 with the alternate configuration shown in FIG. 10. In particular, the same components described in FIG. 9 are used to reconfigure the confined space entry device 711 in FIG. 10; however, elbow 718 is reversed, meaning its shorter leg 721 connects to upper end 733 of vertical member 731, and its longer leg 723 extends upwardly and outwardly from vertical member 714, and is connected to extension tube 722.

In this way, a horizontal offset 835, shown in FIG. 10, is created, and such offset 835 is longer than the offset 735 shown in FIG. 9 by virtue of having extension 722 connected to the longer leg 723 of elbow 718. In this embodiment, longer offset 835 is approximately 24′.

Tubular member 714 and 722 are preferably made of lightweight material, more preferably lightweight metal, and most preferably lightweight aluminum, such as aluminum of the type 6061-T6. Alternate types of aluminum are also suitable, such as the 7000 series, including 7071, or aluminum composites, or DURALCAN material. Members 714 and 722 are ⅜ inches thick, with 3 inch outside diameters. A suitable material for elbow 718 has been found to be cast alumamag 535. Legs 721 and 723 have been found suitable when joined at an angle ranging between approximately 120° and 150°, preferably approximately 140°, with leg 721 extending approximately 9 inches and leg 723 extending approximately 15.25 inches from central axis 719.

In addition to the advantages apparent from the foregoing description, the confined space entry devices of the present invention are more effectively “componentized” or modularized.

Such modularity has the attendant advantages of allowing users to customize the configurations of the confined space devices using a limited number of interchangeable components. The asymmetric design of the elbow according to one aspect of the present invention results in variations in offsets without requiring a second extension tube or a different elbow.

The modular components of the present invention are more compact and thus more readily transportable.

When formed of a suitable composite material, the elongated extension tube absorbs forces associated with arresting of a fall. Such absorption of forces, in turn, has the advantage of reducing the risk of hoist line ruptures or other undesired deformations of the structural members of the confined space device.

It is understood that the above-described preferred embodiments are but selected illustrations of the present invention, and that further alternative embodiments may be devised by those of ordinary skill in the art. Such alternatives, as well as others which skill or fancy may suggest, are considered to fall within the scope of the current invention, which is defined by the claims appended hereto.

What is claimed is:

1. A device for use in entering or exiting confined spaces, the device comprising:
multiple elongated members removably secured to corresponding joint sections, the joint sections including an elbow having two legs extending outwardly at an angle from a central axis, the elongated members including a post and an extension arm; the post having opposite ends; the arm having a proximal end and a free end;
wherein one leg of the elbow is removably secured to one of the ends of the post and the other leg of the elbow is removably secured to the proximal end of the extension arm, the free end of the extension arm being spaced a lateral distance from the post to define an offset;
the device further comprising means for hoisting loads into and out of the confined space, the hoisting means including a line operatively extending from the extension arm.
